(19) United States
(12) Patent Application Publication
(10) Pub. No.: US 2006/0105154 A1
(43) Pub. Date: May 18, 2006

(54) Single layer substrate

(75) Inventor: Tony Sutton, Palm Beach (AU)

Correspondence Address: RANKIN, HILL, PORTER & CLARK LLP, 4080 ERIE STREET, WILLOUGHBY, OH, 44094-7836, US

(73) Assignee: WOVEN IMAGE PTY LTD, Warriewood (AU)

(21) Appl. No.: 10/987,905

(22) Filed: Nov. 12, 2004

(51) Int. Cl. B32B 27/32

(52) U.S. Cl. 428/220

(57) ABSTRACT

A substrate comprising a single layer of compressed fibrous polyethylene terephthalate, his-density polyethylene, polyvinyl chloride, low-density polyethylene, polypropylene, polystyrene or acrylonitrile butadiene styrene, being substantially rigid and having a thickness of between approximately 6 mm and approximately 12 mm.

### BACKGROUND OF THE INVENTION

The present invention relates to rigid substrates for use in building and interior design and, in particular, to a single-layer rigid substrate.

The invention is being described in relation to wall panels and partitions, however any building or interior requiring a rigid substrate could be substituted.

A significant number of screens are produced every year around the world for use in offices. The desire for screens ranges from the aesthetics of office presentation to privacy of workers by substantially enclosing their work area in a cubicle. Further, screens have acoustic properties and produce noise in a workspace by providing a buffer between workstations. The screens are used around desks or other office furniture where the screens extend any distance from a floor or some distance above it up to a ceiling or some distance below it. The screens are also often used as pinboards and vertical supports that maintain the screens are often used to support shelves extending across a portion of one or more of the screens.

Perhaps the most commonly produced screens employ metal vertical supports configured to releaseably engage an edge of adjacent screen panels. A number of the panel screens are arranged in this manner to provide a screen enclosing the work area. Similarly, a linear arrangement of the panel screens can be disposed at the front or rear of the work area or other office furniture.

The panel screens can be practically any size. However, the screens are often one two meters wide and between one and three meters high and are relatively expensive to produce. The panel screens are generally composed of wood, typically in the form of MDF or other compressed boards or particleboards, where two sheets of the wood are cut to measure and are disposed such that a major face of each wood sheet is adjacent one another. A dowel or other spacer is adhered to each major adjacent face, such that the sheets are spaced apart the size of the spacer. The spacer is generally disposed to define a recess between the spacers and the periphery of the wood sheets.

The outer major face of each wood sheet is then painted, covered with a cloth material or otherwise decorated. Frequently a foam backing is used to provide acoustic properties and a softer surface. An edging, often metal is then applied to cover the edges of the wood sheets and the recess created by the spacer.

In the case of cloth or foam backing and cloth being applied to the outer major faces of the wood sheets, the edges of the cloth are concealed by the edging. The cloth can be retained by the edging, by tacking its edges within the recess, by adhering the cloth with a glue composition or by other commensurate means. The cloth can be of a uniform colour or be otherwise decorated.

These common screens are complex to produce, requiring many steps, and become even more complex to mass-produce where constant tolerances are required and substantial material handling occurs. Furthermore, many countries require that a significant portion of the screens be recyclable. For example, in Japan, 49% of the material comprising the screen needs to be recyclable. This therefore increases the cost of producing the screens.

It is an object of the invention to provide a rigid single layer substrate which will substantially ameliorate at least some of the deficiencies of the prior art, or at least to provide an alternative.

### BRIEF SUMMARY OF THE INVENTION

According to a first aspect of the invention there is provided a substrate comprising a single layer of compressed fibrous polyethylene terephthalate, high-density polyethylene, polyvinyl chloride, low-density polyethylene, polypropylene, polystyrene, or acrylonitrile butadiene styrene, the substrate being substantially rigid and having a thickness of between approximately 6mm and approximately 12 mm.

According to a second aspect of the invention there is provided a method of producing a substrate, the method comprising;
layering polyethylene terephthalate, high-density polyethylene, polyvinyl chloride, low-density polyethylene, polypropylene, polystyrene, or acrylonitrile butadiene styrene;
rolling the layered mixture into a sheet;
needle punching the sheet;
lapping the sheet;
heating the sheet to a predetermined temperature; and,
compressing the sheet.

### BEST MODE OF THE INVENTION

The present invention is a substrate comprising a single layer of fibrous polyethylene terephthalate, high-density polyethylene, polyvinyl chloride, low-density polyethylene, polypropylene, polystyrene, or acrylonitrile butadiene styrene. It can be seen that utilising a single layer substrate in building walls and partitions requires less material and less labour than previously known partition materials. That is, instead of upholstering a metal tile or a piece of MDF or plasterboard, the single layer of substrate provides the finished surface along with the support. This removes the cost of fabric, foam and adhesive, and requires reduced materials handling.

Moreover, this single layer has less weight than the previously known screen and partition systems. The present invention weighs approximately 2,400 grams per square metre at a 12 mm thickness. This is approximately one third of the weight of MDF board or plasterboard of an equivalent thickness.

Further the single layer substrate can be utilized more flexibly than the equivalent previously known screen and partition systems. The single layer substrate can be cut into a variety of shapes and configurations allowing designers to redefine the office partition.

Preferably the substrate is composed of recycled or recyclable polyethylene terephthalate, high-density polyethylene, polyvinyl chloride, low-density polyethylene, polypropylene, polystyrene, or acrylonitrile butadiene styrene. The combination of fewer materials and utilizing recycled or recyclable material has significant benefit for the environment.

The substrate thickness is between approximately 6 mm and 12 mm. This thickness is sufficient for providing a partition or screen which can be utilised as a pinboard and has useful acoustic properties to block sound.

The substrate of the present invention is produced by the process of layering polyethylene terephthalate, high-density polyethylene, polyvinyl chloride, low-density polyethylene, polypropylene, polystyrene, or acrylonitrile butadiene styrene, and rolling the layered mixture into a sheet The sheet is then needle punched and lapped before heating the sheet to a predetermined temperature This heating step provides screen rigidity. It can be seen that the polyethylene, polypropylene, polystyrene, or acrylonitrile butadiene styrene acts effectively as an adhesive upon heating. The sheet is then compressed into a finished substrate.

Before the step of layering the polyethylene terephthalate, high-density polyethylene, polyvinyl chloride, low-density polyethylene, polypropylene, polystyrene, or acrylonitrile butadiene styrene adhesive mixture, dye may be added to the mixture. It can be seen that colouring the mixture while it is still in solution means the dyes stay in solution and effectively become a component of the fibre so there is no dye-including effluent.

The process for producing the substrate of the present invention is easily compatible with post-industrial recycling. Source fibre that is not transformed into useful product is collected and reused so that no waste is created.

Partitions, screens, acoustic panels, wall panels or roofing utilising the present invention are simple to disassemble and separate into recycling streams, owing to the uncomplicated nature of the material. This means the present invention is particularly compatible with the recycling process. In contrast MDF board or plasterboard covered with adhesives, foam backing fabrics and fasteners are not particularly compatible with recycling processes.

While the present invention has been described in relation to wall partition and screen systems, other uses, obvious to those skilled in the art, are also available. This includes utilising the substrate as an acoustic floor or wall panel or as a ceiling tile or roof tile.

The term “comprising” (and its grammatical variations) as used herein is used in the inclusive sense of “having” or “including” and not in the exclusive sense of “consisting only of”.

1. A substrate comprising a single layer of compressed fibrous polyethylene terephthalate, high-density polyethylene, polyvinyl chloride, low-density polyethylene, polypropylene, polystyrene or acrylonitrile butadiene styrene, being substantially rigid and having a thickness of between approximately 6mm and approximately 12 mm.

2. A substrate as defined in claim 1, comprising a single layer of compressed polyethylene terephthalate.

3. A substrate as defined in claim 1, wherein the polyethylene terephthalate, high-density polyethylene, polyvinyl chloride, low-density polyethylene, polypropylene, polystyrene, or acrylonitrile butadiene styrene is recycled or recyclable.

4. A substrate as defined in claim 1, wherein the substrate is produced by the process of:
layering polyethylene terephthalate, high-density polyethylene, polyvinyl chloride, low-density polyethylene, polypropylene, polystyrene, or acrylonitrile butadiene styrene;
rolling the layered mixture into a sheet;
lapping the sheet;
heating the sheet to a predetermined temperature; and,
compressing the sheet.

5. A screen comprising the substrate as defined in claim 1.

6. Roofing comprising the substrate as defined in claim 1.

7. An acoustic panel comprising the substrate as defined in claim 1.

8. A wall panel comprising the substrate as defined in claim 1.

9. A method of producing a substrate, the method comprising:
layering polyethylene terephthalate, high-density polyethylene, polyvinyl chloride, low-density polyethylene, polypropylene, polystyrene, or acrylonitrile butadiene styrene;
rolling the layered mixture into a sheet;
lapping the sheet;
heating the sheet to a predetermined temperature;
compressing the sheet

10. A method of producing a substrate as defined in claim 9, wherein the substrate is composed of polyethylene terephthalate.

11. A method of producing a substrate as defined in claim 9, wherein the screen substrate is substantially rigid and has a thickness of between approximately 6mm and approximately 12 mm.

12. A method of producing a substrate as defined in claim 9, wherein the polyethylene terephthalate, high-density polyethylene, polyvinyl chloride, low-density polyethylene, polypropylene, polystyrene, or acrylonitrile butadiene styrene is recycled or recyclable.
